(19) United States
(12) Patent Application Publication
(10) Pub. No.: US 2025/0030766 A1
(43) Pub. Date: Jan. 23, 2025

(54) FORECASTING ENERGY CONSUMPTION IN A MIXED-VEHICLE FLEET

(71) Applicants: VANDERBILT UNIVERSITY, Nashville, TN (US); UNIVERSITY OF HOUSTON SYSTEM, Houston, TX (US)

(72) Inventors: Abhishek DUBEY, Nashville, TN (US); Michael WILBUR, Nashville, TN (US); Ayan MUKHOPADHYAY, Nashville, TN (US); Aron LASZKA, Houston, TX (US)

(21) Appl. No.: 18/708,438

(22) PCT Filed: Nov. 18, 2022
(86) PCT No.: PCT/US2022/080118

§ 371 Date: May 8, 2024

Related U.S. Application Data
(60) Provisional application No. 63/317,276, filed on Mar. 7, 2022.
(60) Provisional application No. 63/280,839, filed on Nov. 18, 2021.

(51) Int. Cl. H04L 67/12; B60L 3/12; G06N 3/096; G07C 5/08

(52) U.S. Cl. CPC H04L 67/12; B60L 3/12; G06N 3/096; G07C 5/08

(57) ABSTRACT

A system for forecasting energy consumption by vehicles in a mixed-vehicle fleet. The system includes neural network(s) that generate a predictive function for vehicles in each of a number of classes (e.g., electric vehicles, hybrid vehicles, internal combustion vehicles, vehicle models, model years, etc.). To capture both the generalizable patterns that govern energy consumption across all vehicle classes and the features and relationships that are specific to each class, the neural network(s) include a multi-task learning model that includes shared layers for all of the classes of vehicles and a set of vehicle-specific layers for each class. In some of those embodiments, for example to predict to energy consumption of an additional class with limited data, the neural networks further include an inductive transfer learning model that includes the shared layers transferred from the multi-task learning model and vehicle-specific layers for the additional class.

### CROSS-REFERENCE TO RELATED APPLICATIONS

This application is related to U.S. Prov. Pat. Appl. No. 63/280,839, filed Nov. 18, 2021, and U.S. Prov. Pat. Appl. No. 63/317,276, filed Mar. 7, 2022, which are hereby incorporated by reference.

### FEDERAL FUNDING

This invention was made with government support under Nasional Science Foundation (NSF) Grant No. 1952011 and Department of Energy (DOE) Grant No. DE-EE0008467. The government has certain rights in the invention.

### BACKGROUND

Affordable public transit services are crucial for communities since they enable residents to access employment, education, and other services. Unfortunately, transit services that provide wide coverage tend to suffer from relatively low utilization, which results in high fuel usage per passenger per mile, leading to high operating costs and environmental impact. Electric vehicles can reduce energy costs and environmental impact, but most public transit agencies have to employ them in combination with conventional, internal-combustion engine vehicles (and/or hybrid vehicles) due to the high upfront costs of electric vehicles.

To make the best use of such a mixed fleet of vehicles, transit agencies need to optimize route assignments and charging schedules, which presents a challenging problem for large transit networks. Specifically, optimizing the operation of mixed fleets is challenging because it requires accurate trip-level predictions of electricity and fuel use for a number of classes of vehicles (e.g., electric, hybrid, internal combustion, model, model year, etc.) and conditions (e.g., traffic conditions, weather conditions, etc.) that may change over time.

Accordingly, there is a need for accurate, dynamic, data-driven prediction of the trip-level energy use of each of a number of types of vehicles in a mixed-vehicle fleet.

### SUMMARY

A system for forecasting energy consumption by vehicles in a mixed-vehicle fleet is disclosed. The system includes neural network(s) that generate a predictive function for vehicles in each of a number of classes, including shared layers for all of the classes of vehicles and a set of vehicle-specific layers for each class (e.g., as a multi-task learning model). In some embodiments, the neural network(s) further include an inductive transfer learning model including the plurality of shared layers (e.g., transferred from the multi-task learning model) and vehicle-specific layers for additional class(es) of vehicle.

In some embodiments, the shared layers identify features indicative of energy consumption and a marginal probability distribution over each of the identified features for all of the classes of vehicles. In those embodiments, the set of vehicle-specific layers for each class identifies a conditional probability distribution over each of the identified features for each class. In other embodiments, the shared layers identify features indicative of energy consumption for all of the classes of vehicles and the set of vehicle-specific layers for each class identifies a marginal probability distribution over each of the identified features and a conditional probability distribution over each of the identified features for each class.

To generate the predictive functions for each class of vehicles, the system stores route data identifying vehicle routes in a geographic area (each vehicle route comprising a plurality of route segments) and receives vehicle locations indicative of locations of each of the vehicles and energy consumption data indicative of energy consumed by each of the vehicles. In some embodiments, the system also stores elevation data indicative of elevations along each route segment and receives traffic data indicative of traffic conditions along at least some of the route segments and/or weather data indicative of weather conditions in the geographic area.

In some embodiments, the features indicative of energy consumption identified by the system include static road segment features (e.g., route length, road classification, change in elevation, maximum elevation change), past vehicle speed features (e.g., average travel speed, time to travel), traffic conditions (e.g., speed ratio, jam factor), and weather conditions (e.g., temperature, precipitation, visibility, wind speed, humidity, wind gust).

In some embodiments, the system generates separate predictive functions for internal combustion vehicles, electric vehicles, and hybrid vehicles. In other embodiments, the system generates a predictive function for each model of vehicle or each year of each model of vehicle.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a diagram of an architecture of an energy consumption forecasting system according to an exemplary embodiment.

FIG. 2 is a block diagram of the energy consumption forecasting system according to an exemplary embodiment.

FIG. 3A is a block diagram illustrating static data stored in a database and dynamic data received from external data sources according to an exemplary embodiment.

FIG. 3B is a block diagram illustrating a route cleaning module according to an exemplary embodiment.

FIG. 3C is a block diagram of a vehicle trajectory mapping module according to an exemplary embodiment.

FIG. 3D is a block diagram of an energy consumption module according to an exemplary embodiment.

FIG. 4 is a block diagram illustrating the features identified by a feature selection module according to an exemplary embodiment.

FIG. 5 is a block diagram of neural networks according to an exemplary embodiment, including a multi-task learning model and an inductive transfer model.

FIG. 6 is a flowchart illustrating an energy consumption prediction process for predicting energy consumption by vehicles in a mixed-vehicle fleet.

FIG. 7 is a flowchart illustrating an energy cost minimization process according to an exemplary embodiment.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

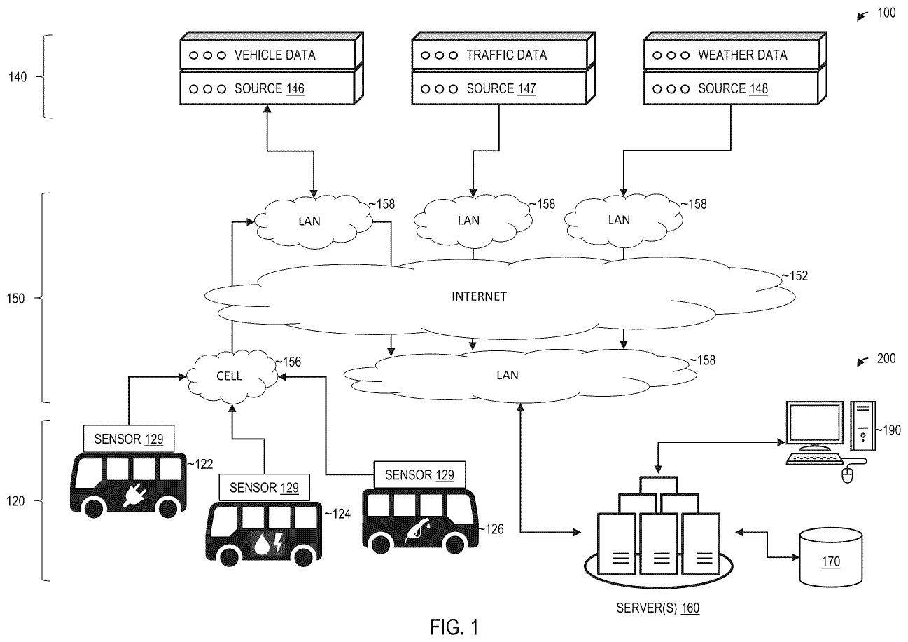

FIG. 1 is a diagram of an architecture 100 of an energy consumption forecasting system 200 according to an exemplary embodiment.

As shown in FIG. 1, the architecture 100 includes one or more servers 160 that communicate with external data sources 140 via one or more networks 150. The network(s) 150 may include, for example, one or more wide area networks 152 (such as the internet), cellular networks 156, and/or local area networks 158. The server(s) 160 include at least one hardware computer processor and non-transitory computer readable storage media 170. The storage media 170 may be internal to the server(s) 160 or external storage media. The architecture 100 may also include a client computing device 190. The server(s) 160 may communicate with the external storage media 170 and/or the client computing device 190 via a wired connection, a wireless connection, the network(s) 150, etc.

As described in detail below, the server(s) 160 forecast the energy consumption of a mixed fleet of vehicles 120. In the embodiment of FIG. 1, for example, the vehicles include electric vehicles 122, hybrid vehicles 124, and internal combustion vehicles 126. Each vehicle 120 includes a vehicle sensor 129 and the external data source(s) 140 include a vehicle data source 146 (e.g., ViriCiti) that receives sensor data from each of the vehicle sensors 129 via the one or more networks 150. In some embodiments, the external data sources 140 may also include a traffic data source 147 (e.g., HERE Technologies) and/or a weather data source 148 (e.g., Dark Sky).

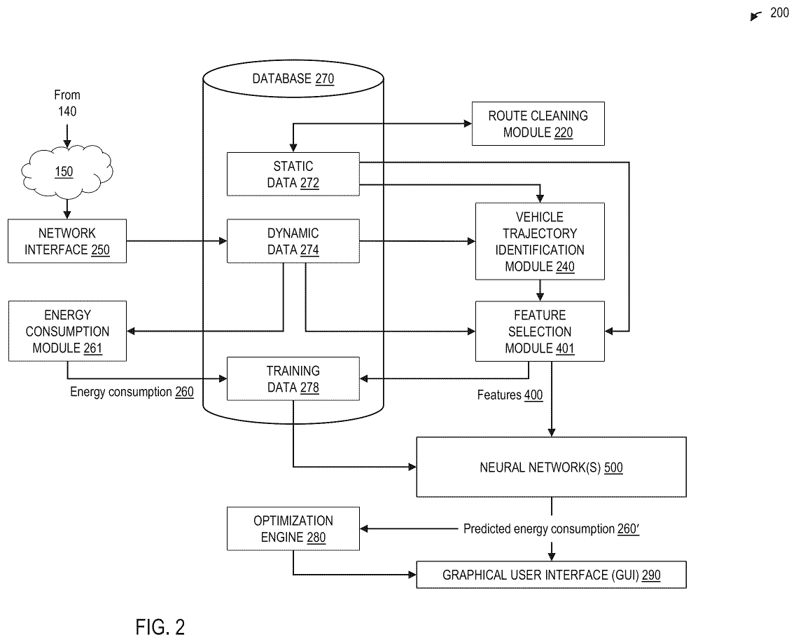

FIG. 2 is a block diagram of the energy consumption forecasting system 200 according to an exemplary embodiment.

In the embodiment of FIG. 2, the energy consumption forecasting system 200 includes a network interface 250, a database 270 (stored, for example, in the storage media 170), a route cleaning module 220, a vehicle trajectory identification module 240, an energy consumption module 261, a feature selection module 401, one or more neural networks 500, an optimization engine 280, and a graphical user interface 290. The route cleaning module 220, the vehicle trajectory identification module 240, the energy consumption module 261, the feature selection module 401, the one or more neural networks 500, and the optimization engine 280 may be realized by software instructions executed by the server(s) 160. The graphical user interface 290 may be realized by software instructions executed by the server(s) 160 and/or the client computing device 190.

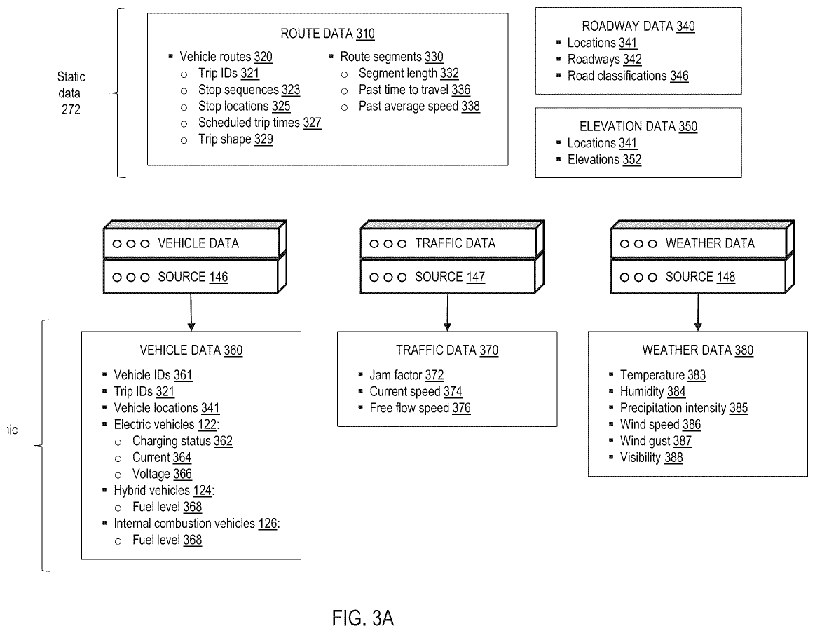

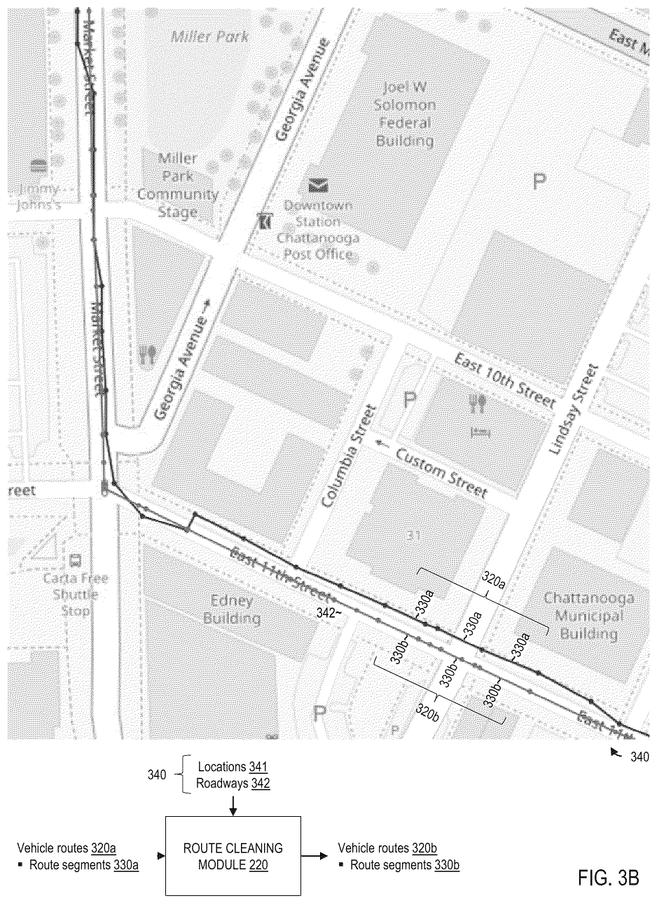

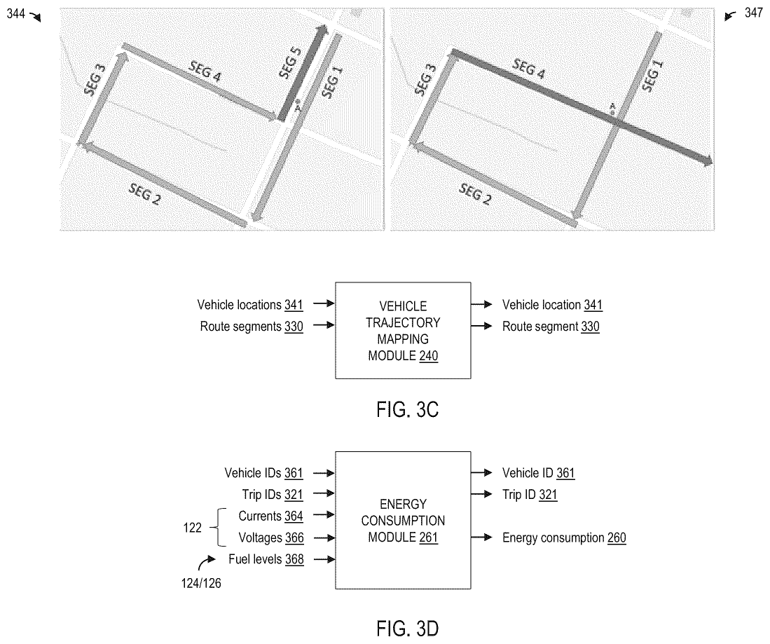

The database 270 stores static data 272 and dynamic data 274 received from the external data sources 140 by the network interface 250 via the one or more networks 150. The static data 272 and the dynamic data 274 are described in detail below with reference to FIG. 3A.

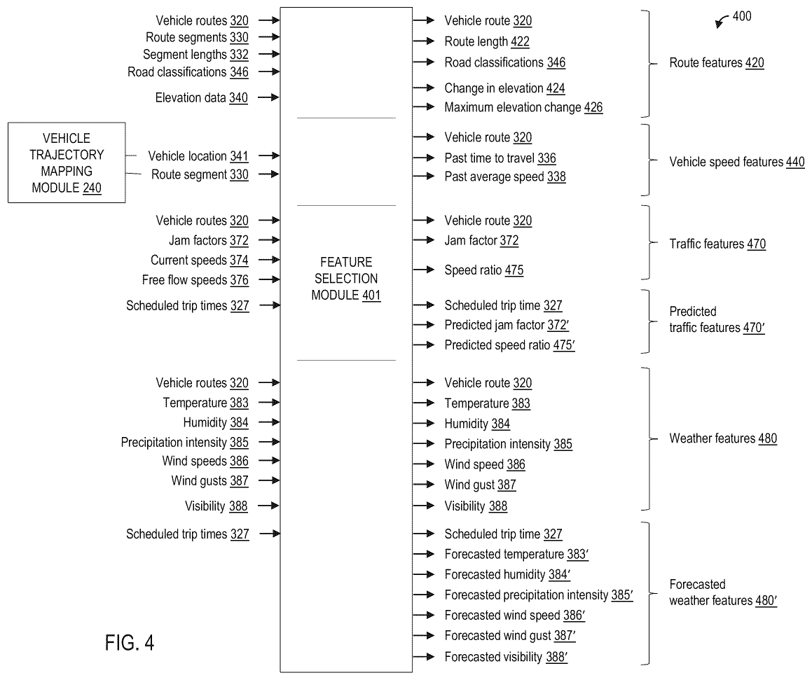

As described in detail below with reference to FIG. 3D, the energy consumption module 261 uses the dynamic data 274 to calculate the past energy consumption 260 of each of the vehicles 120. As described in detail below with reference to FIG. 4, the feature selection module 401 identifies features 400 indicative of the energy consumption 260 of each vehicle 120 in the static data 272 and the dynamic data 274. Together, the past energy consumption 260 calculated by the energy consumption module 261 and the features 401 identified by the feature selection module 400 form training data 278, which is stored in the database 270.

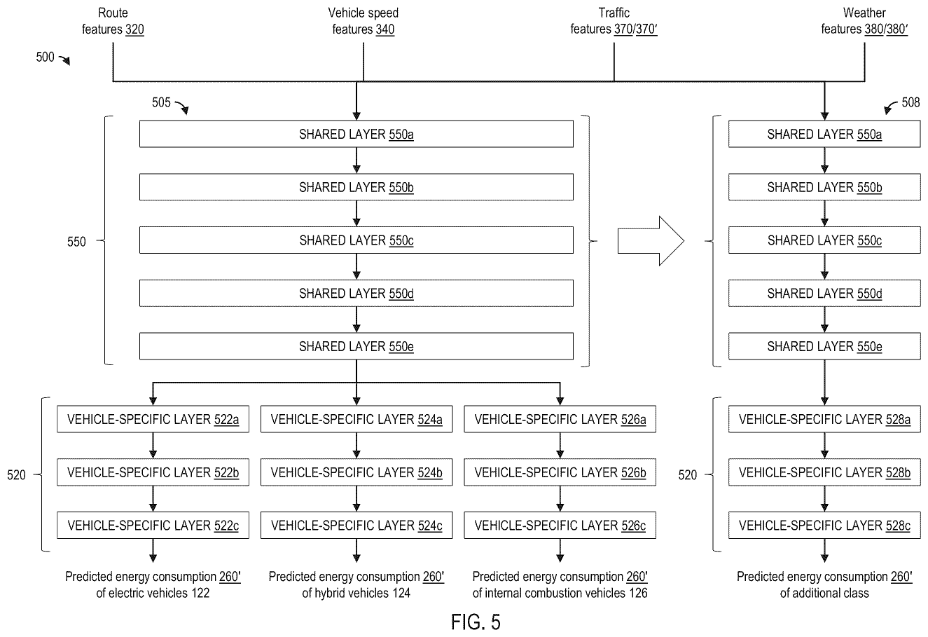

As described in detail below with reference to FIG. 5, the neural network(s) 500 are trained, using the training data 278, to identify the forecasted energy consumption 260′ of each vehicle 120 using the features 401 identified by the feature selection module 400.

FIG. 3A illustrates the static data 272 stored in the database 270 and the dynamic data 274 received from the external data sources 140 according to an exemplary embodiment.

The dynamic data 274 includes vehicle data 360 received from the vehicle sensors 229 via the vehicle data source 146 (e.g., ViriCiti). In the embodiment of FIG. 3A, the vehicle data 360 includes vehicle identifiers 361 identifying each vehicle 120, trip identifiers 321 identifying the trips of each vehicle 120, and the locations 341 of each vehicle 120. For electric vehicles 122, the vehicle data 360 includes the current 364 and voltage 366 of the battery of each electric vehicle 122. (In some embodiments, the vehicle data 360 may also include the charging status 362 of the battery.) For hybrid vehicles 124 and internal combustion vehicles 126, the vehicle data 360 includes the fuel level 368 of each vehicle 120.

In some embodiments, the dynamic data 274 also includes traffic data 370 received from the traffic data source 147. As shown in FIG. 3A, the traffic data 370 may include the jam factor 372 and current speed 374 along some of the major roadways in the geographic area along with the free flow speed 376 along those major roadways. The traffic data 370 may be Traffic Message Channel data received (for example, from HERE Technologies) via the internet 152.

In some embodiments, the dynamic data 274 also includes weather data 380 received from the weather data source 148. As shown in FIG. 3A, the weather data 380 may include the temperature 383, humidity 384, precipitation intensity 385, wind speed 386, wind gust 387, and visibility 388 at one or more locations in the geographic area.

In the embodiment of FIG. 3A, the static data 272 includes route data 310, roadway data 340, and elevation data 350. The route data 310 includes vehicle routes 320, each vehicle route 320 including a number of route segments 330. For each vehicle route 320, the route data 310 may include a trip identifier 321, stop sequences 323, stop locations 325, scheduled stop times 327, and a trip shape 329. For each route segment 330, the route data 310 may include a segment length 332, the past time to travel 336 of each vehicle 120 along the route segment 330, and the past average speed 338 along the route segment 330.

The roadway data 340 includes the roadways 342 at each of a number of locations 341 in a geographic area and the road classification 346 (e.g., motorway, trunk, primary, secondary, tertiary, residential, etc.) of each of the roadways 342. The roadway data 340 may be, for example, one or more Open Street Map edges and nodes files. The elevation data 350 includes the elevation 352 of a number of locations 341 in a geographic area. The elevation data 350 may be one or more raster data files (for example, in ADF format). The roadway data 340 and the elevation data 350 may be stored locally (e.g., in the computer readable storage media 170) or accessed by the server(s) 160 via the internet 152.

In some embodiments, the vehicle routes 310 (e.g., including the trip IDs 321, stop sequences 323, stop locations 325, scheduled trip times 327, and trip shapes 329) and route segments 320 may be provided by a transit system in the form of one or more geographic information system (GIS) shape files in accordance with the general transit feed specification (GTFS), which may be stored locally (e.g., in the computer readable storage media 170) or accessed by the server(s) 160 via the internet 152. In other embodiments, however, the energy consumption forecasting system 200 may be configured to identify those vehicle routes 320 and route segments 330 using vehicle locations 341 (for example, if route data 310 is unavailable). For instance, the energy consumption forecasting system 200 may match the recorded locations 341 of each vehicle 120 in the vehicle data 360 with the locations 341 of each roadway 342 in the roadway data 340, for example as described Ayman et al, “Data-Driven Prediction and Optimization of Energy Use for Transit Fleets of Electric and ICE Vehicles,” ACM Transactions on Internet Technology, Vol. 22, Issue 1 (February 2022), pp. 1-29, https://doi.org/10.1145/3433992. In some embodiments, the energy consumption forecasting system 200 may calculate the segment lengths 332 (e.g., by using the roadway data 340 to measure the length of each route segment 330) and/or the past time to travel 336 and past average speed 338 (e.g., by using the vehicle locations 341 included in the vehicle data 360 and averaging past travel times and past travel speeds along each route segment 330).

FIG. 3B is a block diagram illustrating the route cleaning module 220 according to an exemplary embodiment.

In some instances, the vehicle routes 320 and route segments 330 (as defined, for example, in GTFS files provided by a transit system) may not align with the locations 341 of roadways 342 as indicated in the roadway data 340. Accordingly, in some embodiments, the energy consumption forecasting system 200 may include a route cleaning module 220 that cleans the route data 310 to better align with the location 341 of roadways 342 as indicated in the roadway data 340. In the example shown in FIG. 3B, for instance, the route cleaning module 220 uses Open Street Routing Machine's Match API (Application Programming Interface) to match the location 341 of each route segment 330a of each vehicle route 320a to locations 341 of roadways 342 and updates the coordinates of each route segment 330a and vehicle route 320a to form the route segments 330b and vehicle routes 320b shown in FIG. 3B.

FIG. 3C illustrates the vehicle trajectory mapping module 240 according to exemplary embodiments.

The vehicle trajectory mapping module 240 maps each vehicle location 341 output by the vehicle sensors 229 to one of the route segments 330 in the route data 310. By joining the vehicle data 360 (from the vehicle data source 146) and the sensor data from the vehicle sensors 229, the vehicle trajectory mapping module 240 identifies a set of vehicle locations 341 (GPS points) that a vehicle 120 traverses. That ordered sequence of points is referred to as a trajectory T consisting of spatial points {l₁, l₂, . . . }. Consider that the trajectory T serves the trip R. The goal of the mapping process is to label each location 341 (lᵢ∈T) to a corresponding route segment 332 (SEGⱼ∈R), thereby representing the specific route segment 330 that each vehicle 120 traverses at a specific point in time.

In principle, it is possible to perform an exhaustive search on the route segments 330 to identify the route segment 330 that matches (or is the closest to) each vehicle location 341 in a trajectory. However, such an approach does not work in practice with real-word trajectory feeds due to two reasons. First, vehicle routes 320 often traverse multiple route segments 330 that are close to one another or overlap at multiple times during trips. For example, consider the overlapping segments in map 344 in which the vehicle passes through segment SEG₁ relatively early in the trip and through segment SEG₅ later. Due to noise in the measurement, a point early in the trip can erroneously get mapped to SEG₅, resulting in incorrect representation of the features that are induced by the route segment 330. Similar problems arise when segments cross each other as shown in map 347. Second, the mapping of vehicle locations 341 to route segments 330 is computationally challenging for transit agencies. Consider, for example, the New York Metropolitan Transit Authority (NY-MTA), which operates more than 5,000 buses. If vehicle locations 341 are collected at the frequency of 1 Hz for 3 years, the matching must be done for over 3.5×10⁹ spatial locations, each of which could potentially be mapped to one of hundreds of route segments 330. For a large city like New York, the number of matches is 3.5×10¹².

To alleviate those concerns, in some embodiments, the vehicle trajectory mapping module 240 takes the trajectory T of the vehicle 120 traversing the sequence of segments (SEG) of trip R and maintains a lookahead window, denoted by W, that represents the number of route segments 330 to consider for the match. For example, if a location lᵢ∈T is already matched to segment SEG, along a vehicle route 320, then for matching the next location lᵢ₊₁∈ T, the vehicle trajectory mapping module 240 considers the set {SEG_{C}, . . . , SEG_{c+W}}. By maintaining a short lookahead, the vehicle trajectory mapping module 240 avoids duplicate matches from route segments 330 further away in the vehicle route 320. Also, a shorter lookahead provides computational efficiency compared to an exhaustive search. The vehicle trajectory mapping module 240 may also maintain a tolerance distance B for matching, where a vehicle location is matched to a route segment 330 only if the distance between them is less than or equal to B.

FIG. 3D is a block diagram of the energy consumption module 261 according to exemplary embodiments.

The energy consumption module 261 calculates the energy consumed by each vehicle 120 (identified, for example, using the vehicle identifier 361) during each trip (identified, for example, using the trip identifier 321). The energy consumption module 261 calculates the energy consumption 260 of hybrid vehicles 124 and internal combustion vehicles 126 by calculating the difference between fuel levels 368 at two datapoints. The energy consumption module 261 calculates the energy consumption 260 (Eᵢ) of electric vehicles 122 between two datapoints i−1 and i based on the recorded battery current 364 (Aᵢ) and voltage 366 (Vᵢ) as follows:

$${E}_{i} = {A}_{i} \cdot {V}_{i} \cdot ( {TS}_{i} - T {S}_{i - 1} )$$

where TSᵢ is the timestamp of datapoint i.

FIG. 4 is a block diagram illustrating the features 400 identified by the feature selection module 401 according to an exemplary embodiment. As shown in FIG. 4, the features 400 may include route features 420 and vehicle speed features 440. As described above, the feature selection module 401 identifies features 400 of past trips for use as part of the training data 278 that is used to train the neural network(s) 500. In some embodiments, those features 400 include traffic features 470 and/or weather features 480. As described below, the energy consumption forecasting system 200 is also used to predict future energy consumption. To calculate forecasted energy consumption 260′, the features 400 may include current traffic features 470, current weather features 480, forecasted traffic features 470′, and/or current weather features 480′.

In the embodiment of FIG. 4, for each vehicle route 320, the route features 420 include the route length 422, the road classification(s) 346, the change in elevation 424, and the maximum change in elevation 426: the vehicle speed features 440 include the past time to travel 336 and the past average speed 338: the traffic features 470 include the jam factor 372 and the speed ratio 475 (e.g., the ratio between the current speed 374 of the vehicle route 320 and the free flow speed 376 of that vehicle route 320); and the weather features 480 include the temperature 383, the humidity 384, the precipitation intensity 385, the wind speed 386, the wind gust 387, and the visibility 388 in the geographic area of the route 320. To calculate forecasted energy consumption 260′, the energy consumption forecasting system 200 may utilize the current traffic features 470 and/or weather features 480. Alternatively, for each scheduled trip time (e.g., scheduled stop times 327 of each vehicle route 320), the feature selection module 401 may identify predicted traffic features 470′ (e.g., a predicted jam factor 372 and/or predicted speed ratio 475) and/or forecasted traffic features 480′ (e.g., forecasted temperature 383′, forecasted humidity 384′, forecasted precipitation intensity 385′, forecasted wind speed 386′, forecasted wind gust 387′, and/or forecasted visibility 388′).

FIG. 5 is a block diagram of the one or more neural networks 500 according to an exemplary embodiment.

As shown in FIG. 5, the neural network(s) 500 include a multi-task learning model 505 that includes a number of shared layers 550 (e.g., five shared layers 550a through 550e) and a set of vehicle-specific layers 520 for each class of vehicles 120. In the embodiment of FIG. 5, for instance, the multi-task learning model 505 includes a set of vehicle-specific layers 522a through 522c for electric vehicles 122, a set of vehicle-specific layers 524a through 524c for hybrid vehicles 124, and a set of vehicle-specific layers 526a through 526c for internal combustion vehicles 126.

In some embodiments, to generate a predictive function for predicting energy consumption 260′ by vehicles 120 in the class, the shared layers 550 identify features 400 indicative of energy consumption 260 and a marginal probability distribution over each of the identified features 400 and each set of vehicle-specific layers 520 identifies a conditional probability distribution over each of the identified features 400.

To predict the energy consumption 260′ of vehicles 120 in each class (e.g., electric vehicles 122, hybrid vehicles 124, and internal combustion vehicles 126) of a mixed-vehicle fleet, a predictive model ƒ can be learned over each vehicle class. However, recognizing that there are generalizable patterns between vehicle classes that can be leveraged to aid learning, the multi-task learning model 505 uses shared layers 550 with hard parameter sharing to learn a common representation of the input features 400, which enables the multi-task learning model 505 to extract generalizable patterns that are applicable to all classes of vehicles 120. Additionally, the multi-task learning model 505 includes a set of vehicle-specific hidden layers 520 for each class of vehicles 120 that output the predicted energy consumption 260′ for that class of vehicles 120.

A domain D may be defined as the combination of a feature space X and a probability distribution P(X), where X={x₁, x₂, . . . }∈X. For example, X can include features 400 like the vehicle speed features 440 and the weather features 480 or 480′. Given a specific domain D, a task may be defined as T={Y, ƒ(⋅)} where Y is the space of output labels, and f is a predictive function over y∈Y conditional on x. Probabilistically, ƒ denotes the probability of a realization of y given x (P(y|x)). For example, Y can denote the energy consumed 260 by a vehicle 120, and subsequently, the function ƒ can be used to denote a distribution on the energy consumed 260 conditional on the determinants. Typically, ƒ is unknown: instead, we assume access to observations (data) in the form of input-output pairs {(x₁, y₁), (x₂, y₂), . . . , (xₘ, yₘ)}. We deal with a scenario with multiple tasks (and associated domains). Specifically, there are three domains D: the domain D_{EV} of electric vehicles 122, the domain D_{HV} of hybrid vehicles 124, and the domain D_{ICEV} of internal combustion vehicles 126. Accordingly, the multi-task learning model 505 learns three output label spaces (Y_{EV} for electric vehicles 122, Y_{HV} for hybrid vehicles 124, and Y_{ICEV} for internal combustion vehicles 126) and three predictive functions (ƒ_{EV} for electric vehicles 122, ƒ_{HV} for hybrid vehicles 124, and ƒ_{ICEV} for internal combustion vehicles 126).

The functions ƒ_{EV}, ƒ_{HV}, and ƒ_{ICEV} are parameterized by a set of parameters θ, which the multi-task learning model 505 seeks to learn by minimizing a predefined loss function given the observed data. As described above, the input features 400 for each of the vehicle class domains are derived from the characteristics of the road segments, weather, traffic features, and vehicle dynamics. Therefore, we can state that the feature spaces are equivalent, X_{EV}=X_{HV}=X_{ICEV}. Additionally, the marginal probability distributions over the features 400 may be independent of vehicle class. Therefore, in some embodiments, the multi-task learning model 505 treats the marginal probability distributions over the features 500 as equivalent:

$$P ( {X}_{E V} ) = P ( {X}_{H V} ) = P ( {X}_{ICEV} )$$

In those embodiments where the feature spaces X and marginal probability distributions P (X) are the same for all vehicle classes, the multi-task learning model 505 treats the domains D as equivalent:

$${D}_{E V} = {D}_{H V} = {D}_{I C E V}$$

Because the performance of the three vehicle classes varies greatly, the multi-task learning model 505 considers that the predictive functions for each vehicle class are different and the conditional probability distributions are not equal

$$P ( {Y}_{E V} \vert {X}_{E V} ) \neq P ( {Y}_{H V} \vert {X}_{H V} ) \neq P ( {Y}_{ICEV} \vert {X}_{ICEV} )$$

At each training iteration, a batch of samples (e.g., from electric vehicles 122, hybrid vehicles 124, and internal combustion vehicles 126) is fed through the neural network(s) 500 and mean-squared error (MSE) loss is calculated between the predicted target and true target for each vehicle class. The gradient of the loss is then propagated back through the neural network(s) 500. The predicted energy consumption 260′ for hybrid vehicles 124 and internal combustion vehicles 126 is measured in volume of fuel consumed (e.g., liters). Accordingly, in those instances, the space of output labels Y is the set of positive real numbers [symbol] ₊. On the other hand, because electric vehicles 122 have regenerative braking, the predicted energy predicted energy consumption 260′ may be negative. Accordingly, for electric vehicles 122, the space of output labels Y is [symbol] .

In the embodiment of FIG. 5, the multi-task learning model 505 has three sets of vehicle specific layers 520 for each of three classes of vehicles: electric vehicles 122, hybrid vehicles 124, and internal combustion vehicles 126. In other embodiments, however, additional classes may be identified. For example, the multi-task learning model 505 may include a set of vehicle specific layers 520 for each model of vehicle 120 in the mixed-vehicle fleet, each year of each model in the mixed-vehicle fleet, etc. In those embodiments, the multi-task learning model 505 learns the task for each class of vehicle 120 {T₁≠T₂, . . . , ≠Tₙ}∈T, given the domains those classes of vehicles 120 {D₁=D₂, . . . , =Dₙ}∈D.

In some instances, the number of vehicles 120 in each class can vary significantly. For example, a mixed-vehicle fleet may include a large number of vehicles 120 in one class and a significantly smaller number of vehicles 120 in another class. In those instances, while the multi-task learning model 505 can learn a common model, the class with a significantly larger number of vehicles 120 are likely to dominate the learning. Also, learning a model solely for a class of vehicles 120 having few samples can result in overfitting. Therefore, to predict energy consumption 260′ by an additional class of vehicles 120, the neural network(s) 500 may also include an inductive transfer model 508. As shown in FIG. 5, the inductive transfer model 508 includes the shared layers 550 of the multi-task learning model 505 and an additional set of vehicle-specific layers 520 (e.g., vehicle-specific layers 528a through 528c) for the additional class of vehicle 120. In the inductive transfer model 508, the layer parameters of the shared layers 550 are frozen and only the vehicle-specific layers 528a through 528c are updated during training. Accordingly, the inductive transfer model 508 can learn the generalizable patterns that are applicable to all classes of vehicles 120 from the multi-task learning model 505 using only the vehicle classes with sufficient data and transfer the learned abstraction to improve the predictive accuracy for an additional class of vehicles 120 with fewer data samples.

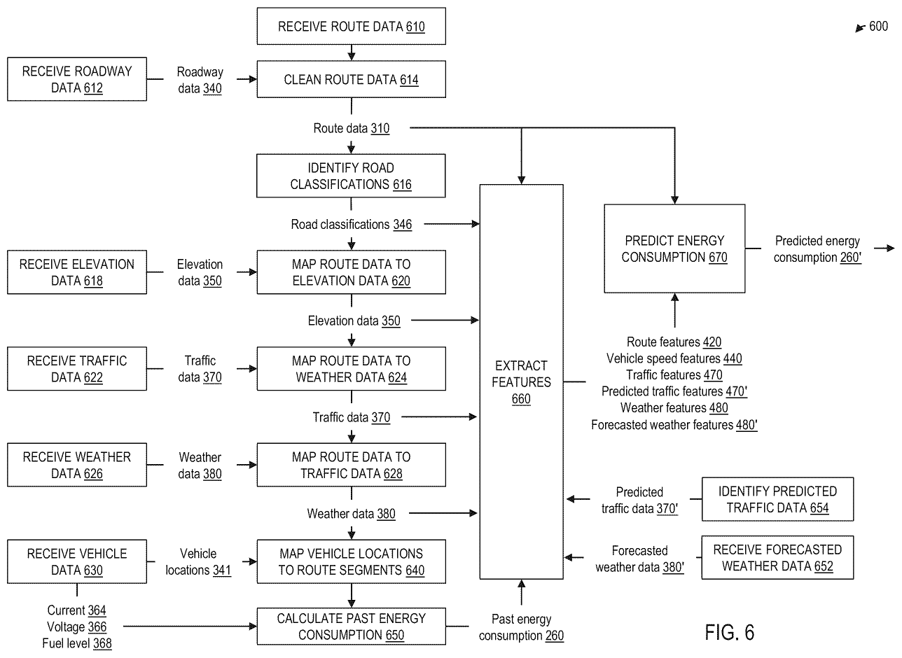

FIG. 6 is a flowchart illustrating an energy consumption prediction process 600 for predicting energy consumption by vehicles in a mixed-vehicle fleet. The energy consumption prediction process 600 may be performed, for example, by the server(s) 160. As one of ordinary skill in the art will recognize, some of the processing steps below may be optional and do not necessarily have to be performed in the order shown in FIG. 6 and described below.

In the embodiment of FIG. 6, route data 310 (e.g., GTFS files) identifying vehicle routes 320 as a series of route segments 330 in a geographic area is received in step 610. Roadway data 340 (e.g., Open Street Map data) is received in step 612. The route data 310 may be cleaned, for example by the route cleaning module 220 as described above, by matching the route segments 330 of the vehicle routes 320 to the locations 341 of roadways 342 as indicated by roadway data 340 (e.g., using OSRM's Match API) in step 614. The road classifications 346 (e.g., motorway, trunk, primary, secondary, tertiary, residential, etc.) of route segments 330 are identified (e.g., using the roadway data 340) in step 616.

Elevation data 350 (e.g., one or more raster data files) is received in step 618 and mapped to the route data 310 in step 620. For instance, the system 200 may identify the elevation 352 at the start and end of each route segment 330, the total change in elevation 424 along each vehicle route 320, the maximum change in elevation 426 along each vehicle route 320, etc.

Traffic data 370 (e.g., the jam factor 372, current speed 374, and free flow speed 376) is received (e.g., every minute) for some or all of the vehicle routes 320 in step 622 and mapped to route segments 320 in step 624, for example by identifying the Traffic Message Channel of each route segment 320 and then querying the traffic data source 147 (e.g., HERE Technologies) for that particular route segment 320.

Weather data 380 (e.g., temperature 383, humidity 384, precipitation intensity 385, wind speed 386, wind gust 387, and visibility 388) is received (e.g., from Dark Sky every five minutes) for one or more locations in the geographic area in step 626 and mapped to the route data 310 in step 628.

In step 630, vehicle data 360 is received (e.g., at 1-second or shorter intervals) from vehicle sensors 129 in each of a plurality of vehicles 120 in a mixed-vehicle fleet (e.g., electric vehicles 122, hybrid vehicles 124, and internal combustion vehicles 126). As described above, the vehicle data 360 may include the vehicle locations 341 of each vehicle 120, the current 364 and voltage 366 of the battery of each electric vehicle 122, and the fuel level 368 of each hybrid vehicle 124 or internal combustion vehicle 126.

The vehicle locations 341 are mapped to the route segments 330 in the route data 310 in step 640, for example by the vehicle trajectory mapping module 240 as described above. The past energy consumption 260 of each vehicle 120 along each vehicle route 320 is calculated in step 650, for example by the energy consumption module 261 as described above.

To predict future energy consumption 260′, for vehicle trips indicated by the route data 310, forecasted weather data 380′ for a specified time period (e.g., an upcoming week) is received in step 652 and predicted traffic data 370′ for the specified time period is identified in step 654.

Features 400 indicative of the past energy consumption 260 (e.g., route features vehicle speed features 440, traffic features 470, weather features 480, etc.) and predictive of future energy consumption 260′ (e.g., predicted traffic features 470′, weather features 480′, etc.) are extracted in step 660, for example by the feature selection module 401 as described above.

The predicted energy consumption 260′ of each of the plurality of types of vehicles 120 (e.g., electric vehicles 122, hybrid vehicles 124, and internal combustion vehicles 126) is forecasted in step 670 for each vehicle trip along each vehicle route 320 indicated by the route data 310, for example by the neural networks 500 using the multi-task learning model 505 and the inductive transfer model 508 described above.

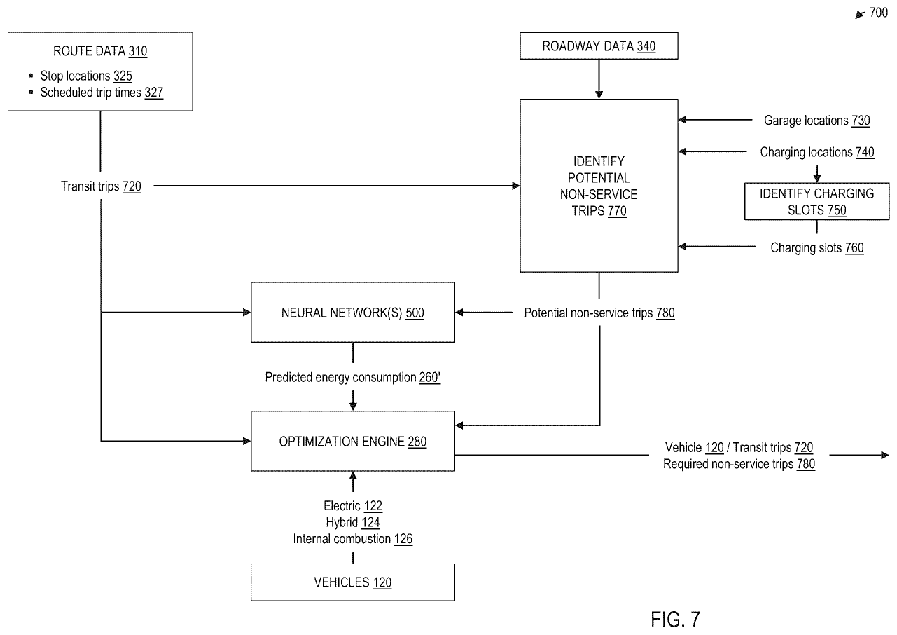

FIG. 7 is a flowchart illustrating an energy cost minimization process 700 according to an exemplary embodiment. The energy cost minimization process 700 may be, for example, as described Sivagnanam et al, “Minimizing energy use of mixed-fleet public transit for fixed-route service,” Proceedings of the AAAI Conference on Artificial Intelligence, Vol. 35 (2021), 14930-14938, https://doi.org/10.1609/aaai.v35117.17752, which is hereby incorporated by reference.

As described above, the route data 310 includes the stop locations 325 and scheduled stop times 327 for each of a number of transit trips 720 along each vehicle route 320. Meanwhile, for vehicles 120 to make each transit trip 720, those vehicles have to make a number of non-service trips 780, for example, from a garage location 730 to the start of the transit trip 720, from the end of the transit trip 720 to a garage location 730. Additionally, for electric vehicles 122, those electric vehicles 122 may also need to make stops at charging locations 740 (e.g., charging poles) to recharge their batteries. Accordingly, each potential non-service trip 780 is identified using the roadway data 340 in step 770.

Because a vehicle 120 that has completed any transit trip 720 can potentially be assigned to any of the other transit trips 720, the potential non-service trip 780 include non-service trips 780 from the end of each transit trip 720 to the start of every other transit trip 720, from each garage location 730 to the start of every transit trip 720, and from the end of every transit trip 720 to every garage location 730. Additionally, charging slots 760 (i.e., time periods during which an electric vehicle 122 may use a specific charging location 740) are identified in step 750 and the potential non-service trips 780 include non-service trips 780 from the end of each transit trip 720 to every charging location 740 and from each charging location 740 to the start of each transit trip 720.

As described above, the neural networks 500 generate the predicted energy consumption 260′ of every vehicle 120 for every transit trip 720. Additionally, the neural networks 500 generate the predicted energy consumption 260′ of every vehicle 120 for every potential non-service trip 780. The optimization engine 280 then uses one or more optimization algorithms (e.g., a greedy algorithm, simulated annealing, etc.), for example as described in Sivagnanam et al, to assign one of the vehicles 120 in the mixed-vehicle fleet to each of the transit trips 720. To assign each of the vehicles 120 to each of the transit trips 720, the optimization engine 280 identifies the vehicle assignments with the minimum total predicted energy consumption 260′ (or minimum total energy cost) to perform each transit trip 720 and each of the required non-service trips 780 for the assigned vehicles 120 to perform each transit trip 720. In some embodiments, the optimization engine 280 may account for constraints on which vehicles 120 may perform each transit trip 720 (e.g., based on passenger capacity).

While preferred embodiments have been described above, those skilled in the art who have reviewed the present disclosure will readily appreciate that other embodiments can be realized within the scope of the invention. Accordingly, the present invention should be construed as limited only by any appended claims.

1. A system for forecasting energy consumption by vehicles in a mixed-vehicle fleet, the system comprising:
non-transitory computer readable storage media that stores:
route data identifying vehicle routes in a geographic area, each vehicle route comprising a plurality of route segments; and
elevation data indicative of elevations along each route segment;
a network interface that receives:
traffic data indicative of traffic conditions along at least some of the route segments;
weather data indicative of weather conditions in the geographic area;
vehicle locations indicative of locations of each of the vehicles; and
energy consumption data indicative of energy consumed by each of the vehicles;
a multi-task learning model comprising:
a plurality of shared layers that identify features indicative of energy consumption and a marginal probability distribution over each of the identified features; and
a set of vehicle-specific layers for each of a plurality of classes of vehicles, each set of vehicle-specific layers identifying a conditional probability distribution over each of the identified features to generate a predictive function for predicting energy consumption by vehicles in the class; and
an inductive transfer learning model comprising:
the plurality of shared layers transferred from the multi-task learning model; and
at least one set of vehicle-specific layers for an additional class of vehicles that identifies a conditional probability distribution over each of the identified features to generate a predictive function for predicting energy consumption by vehicles in the additional class.

2. The system of claim 1, wherein the features indicative of energy consumption comprise:
length of each route;
average past travel speed along each route;
past time to travel along each route;
change in elevation along each route;
maximum elevation change along each route;
speed ratio along each of at least some of the routes;
jam factor along each of at least some of the routes;
temperature in the geographic area;
precipitation in the geographic area;
visibility in the geographic area;
wind speed in the geographic area;
humidity in the geographic area; and
wind gust in the geographic area.

3. A system for forecasting energy consumption by vehicles in a mixed-vehicle fleet, the system comprising:
non-transitory computer readable storage media that stores route data identifying vehicle routes in a geographic area, each vehicle route comprising a plurality of route segments;
a network interface that receives:
vehicle locations indicative of locations of each of the vehicles; and
energy consumption data indicative of energy consumed by each of the vehicles; and
one or more neural networks that generates a predictive function for predicting energy consumption by vehicles in each of a plurality of classes of vehicles, the one or more neural networks comprising a plurality of shared layers for all of the classes of vehicles and a set of vehicle-specific layers for each of the plurality of classes.

4. The system of claim 3, wherein the one or more neural networks comprise a multi-task learning model comprising the plurality of shared layers for all of the classes of vehicles and the sets of vehicle-specific layers for each of the plurality of classes.

5. The system of claim 4, wherein the one or more neural networks further comprise an inductive transfer learning model comprising the plurality of shared layers, transferred from the multi-task learning model, and at least one set of vehicle-specific layers for at least one additional class.

6. The system of claim 3, wherein:
the plurality of shared layers identifies features indicative of energy consumption and a marginal probability distribution over each of the identified features for all of the classes of vehicles; and
for each class, the set of vehicle-specific layers identifies a conditional probability distribution over each of the identified features.

7. The system of claim 3, wherein:
the plurality of shared layers identifies features indicative of energy consumption for all of the classes of vehicles; and
for each class, the set of vehicle-specific layers identifies a marginal probability distribution over each of the identified features and a conditional probability distribution over each of the identified features.

8. The system of claim 3, wherein:
the non-transitory computer readable storage media further stores elevation data indicative of elevations along each route segment; and
a network interface further receives:
traffic data indicative of traffic conditions along at least some of the route segments; and
weather data indicative of weather conditions in the geographic area.

9. The system of claim 8, wherein the one or more neural generates each predictive function by identifying features indicative of energy consumption along each route segment, the features indicative of energy consumption along each route segment including: one or more static road segment features for each route segment, identified using the route data and the elevation data;
one or more past vehicle speed features for each route segment, identified using the vehicle locations;
one or more weather conditions, identified using the weather data; and
one or more traffic conditions, identified using the traffic data.

10. The system of claim 3, wherein:
one of the plurality of classes is internal combustion vehicles and one of the plurality of classes is electric vehicles; and
the energy consumption data is indicative of fuel consumed by the internal combustion vehicles and electric energy consumed and generated by the electric vehicles.

11. The system of claim 10, wherein:
one of the plurality of classes is hybrid vehicles.

12. The system of claim 3, wherein the one or more neural networks comprise a set of vehicle-specific layers for each model of vehicle in the mixed-vehicle fleet.

13. The system of claim 3, wherein the one or more neural networks comprise a set of vehicle-specific layers for each year of each model in the mixed-vehicle fleet.

14. The system of claim 3, further comprising:
a vehicle trajectory mapping module that maps each vehicle location to one of the route segments in the route data.

15. The system of claim 3, wherein the vehicles are buses.

16. A method of forecasting energy consumption by vehicles in a mixed-vehicle fleet, the method comprising:
storing route data identifying vehicle routes in a geographic area, each vehicle route comprising a plurality of route segments;
receiving vehicle locations indicative of locations of each of the vehicles;
receiving energy consumption data indicative of energy consumed by each of the vehicles; and
generating a predictive function, by one or more neural networks, for predicting energy consumption by vehicles in each of a plurality of classes, the one or more neural networks comprising a plurality of shared layers for all of the classes of vehicles and a set of vehicle-specific layers for each of the plurality of classes.

17. The method of claim 16, wherein the one or more neural networks comprise:
a multi-task learning model comprising the plurality of shared layers for all of the classes of vehicles and a set of vehicle-specific layers for each of the plurality of classes; and
an inductive transfer learning model comprising the plurality of shared layers, transferred from the multi-task learning model, and at least one set of vehicle-specific layers for at least one additional class.

18. The method of claim 16, wherein:
the plurality of shared layers identifies features indicative of energy consumption and a marginal probability distribution over each of the identified features for all of the classes of vehicles; and
for each class, the set of vehicle-specific layers identifies a conditional probability distribution over each of the identified features.

19. The method of claim 16, further comprising:
storing elevation data indicative of elevations along each route segment;
receiving traffic data indicative of traffic conditions along at least some of the route segments; and
receiving weather data indicative of weather conditions in the geographic area.

20. The method of claim 19, wherein generating the predictive function for each class of vehicles comprises identifying features indicative of energy consumption along each route segment, the features indicative of energy consumption along each route segment comprising:
one or more static road segment features, identified using the route data and the elevation data;
one or more past vehicle speed features for each route segment, identified using the vehicle locations;
one or more weather conditions identified using the weather data; and
one or more traffic conditions identified using the traffic data.
